(19) United States
(12) Patent Application Publication
(10) Pub. No.: US 2021/0009784 A1
(43) Pub. Date: Jan. 14, 2021

(54) RECYCLING OF COMPOSITES CONTAINING LAYERS UNSUITABLE FOR RECYCLING

(71) Applicant: ENGINEERED FLOORS LLC, Dalton, GA (US)

(72) Inventors: Dimitri ZAFIROGLU, Centreville, DE (US); Stephen TSIARKEZOS, Elkton, MD (US); John Joseph Matthews REES, Chattanooga, TN (US); Anthony DANIELL, Dalton, GA (US); Russ DELOZIER, Dalton, GA (US)

(21) Appl. No.: 16/925,941

(22) Filed: Jul. 10, 2020

Related U.S. Application Data
(60) Provisional application No. 62/872,403, filed on Jul. 10, 2019.
(60) Provisional application No. 62/872,408, filed on Jul. 10, 2019.

(51) Int. Cl. C08J 11/24; C08J 11/16; B32B 38/10; B32B 43/00; B29B 17/02

(52) U.S. Cl. CPC C08J 11/24; C08J 11/16; B32B 38/10; B29B 2017/0293; B29B 17/02; C08J 2400/30; B32B 43/006

(57) ABSTRACT

An added layer attached to a textile sheet using polymeric adhesive placed over a textile sheet or between the textile sheet and an added layer is removed by applying heat or a solvent and at least one of an abrasive action, squeezing, or shaving action to remove the adhesive layer or both the added layer and the adhesive sublayer and to prepare the textile sheet for recycling into a new textile structure, preferably into a textile sheet performing the same function as the original textile sheet.

### CROSS-REFERENCE TO RELATED APPLICATIONS

This Application claims benefit from U.S. Provisional Patent Application No. 62/872,403 filed Jul. 10, 2019 and U.S. Provisional Patent Application No. 62/872,408 filed Jul. 10, 2019, the entire contents of which are incorporated herein by reference.

### TECHNICAL FIELD

Embodiments of the subject matter disclosed herein relate to textiles including floor and wall coverings, recycling of textile sheets and removing layers attached to textile sheets including pressure sensitive adhesives to facilitate the recycling of the textiles.

### BACKGROUND

Textiles can be combined with underlayers, for example, primary backings, for use as carpets or floor tiles. These primary backings mainly provide dimensional stability and strength. Additional underlayers can also be attached to the backside of the textiles. These additional underlayers add to the strength of the product, impart dimensional stability, or provide, for example, a barrier to fluid, adhesion to the floor e.g., from a pressure sensitive adhesive (PSA), slip resistance, and antimicrobial properties.

When these textiles have reached the end of their serviceable life, the textiles and any attached underlayers are processed into recycled material that can be used in the manufacture of new textiles and new products incorporating the textiles. Many composites including textile composites are constructed to be recyclable, i.e., to provide the ability to recycle these composites or products, e.g., flooring tiles, at the end of their post-consumer life cycle or to include these composites or products in post-industrial recycling at the point of manufacturing. Therefore, these composites or products can be recycled back into the same product. Common recycling processes or processing methods used in recycling include shredding, hammer milling, fine grinding, cutting, melting and extruding, among others.

When a given textile and the attached backing contain mutually compatible materials, these components are suitable for introduction into a recycling process for subsequent re-use in the preparation of new products or components such as new backings. These added underlayers, or overlayers, may be incompatible with the remainder of the textiles and unsuitable for recycling. Some added underlayers include tacky materials, e.g., a layer of PSA. Other underlayers are abrasive, e.g., fiberglass, or are chemically incompatible, immiscible or objectionable when mixed with materials present in the textile. Therefore, these additional underlayers need to be completely or mostly removed before the textile is subjected to a recycling process, and particularly to recycling processes involving chopping, shredding or grinding, to prevent problems caused by surface friction, adhesion to machine components, tendency to clog machinery, and clumping. PSA that remains on composites, products or textiles during recycling sticks to and gums up the shredding, cutting, grinding, abrading and shaving mechanisms and surfaces of the recycling machines used in the common processing methods.

In some textile products, a relatively dense overlaid surface fabric is attached to a fibrous backing layer, e.g., a cushioning felt, using adhesive sublayers. Portions of the cushioning felt not involved in the adhesion process can be directly recycled by shredding and re-forming into new felts, but the overlayer added to the felt is intimately interlocked with adhesive. Therefore, it is desirable that this overlayer be removed from the felt to facilitate recycling of the fibers.

Regarding the processing of textiles containing PSA, a coating of PSA applied to a composite such as a textile is used to attach or to secure that composite to a desired surface. A given PSA often contains tackifiers of variable curing power to control the final tackiness or strength of the glue. Tackiness improves the grip between an composite containing the PSA and the surface to which the composite is attached. Pressure sensitive adhesives (PSAs) are typically applied using a hot melt application method. These hot melt application methods include, but are not limited to, swirl-spraying, extruded bead layers, extruded dots or dashes, uniform fiber deposition, slot-die extrusion, patterned-extrusion, smooth roll-coating, patterned roll coating or other hot melt methods. Examples of meltblowing application methods are described in U.S. Pat. Nos. 5,902,540, 5,882,573 and 5,904,298, the entire contents of which are incorporated herein by reference.

In addition to a coating of PSA on one or more locations on the surface of the composite, a protective release sheet, e.g., a silicone or wax coated paper or a thermoplastic film, is applied to the composite at least over the areas containing the PSA. The protective release sheet is removed before attaching the composite to the desired surface. Flooring products such as flooring tiles utilizing PSA and protective release sheets are commonly referred to as “peel and stick” tiles.

Composites, for example, post-consumer and post-industrial flooring tiles, containing PSA cannot be easily recycled using the common processing methods. A potential solution is to remove PSA from the composite. Removal is difficult, because, the PSA has a tacky bond and is mechanically engaged with the composite. For example, PSA proceeds into the porous surface and interstices on the nonwoven felt back of a flooring tile. Carpets and fibrous nonwoven felts are floorcoverings in which the PSA is mechanically entangled or engaged with fibers on the backside.

Improved methods and systems are desired to remove added layers incompatible for recycling along with the remainder of the sheet, including layers containing tacky adhesives, in order to facilitate the recycling of the composite and products including textile products using common or conventional recycling processing methods. In addition, improved methods or systems are desired to provide for the recycling of composites containing pressured sensitive adhesive using common or conventional recycling processing methods.

### SUMMARY

Exemplary embodiments are directed to systems and methods for removing layers, i.e., underlayers or overlayers that are incompatible with recycling and recycling processing methods from composites and products. These composites and products include textiles, primary backings and fibrous layers, e.g., felts. Suitable composites and products also include flooring products, for example, carpet, carpet tiles, luxury vinyl tiling (LVT), luxury vinyl plank (LVP), vinyl composite tiles (VCT), laminate squares, engineered wood flooring and laminate wood flooring, and composites, products or parts of products coated for adhesion such as bumper stickers, tape, padding, stamps, envelopes, cardboard boxes, decals, rubber bumpers, diapers, bandages and molding. The additional underlayers and overlayers that are attached to the composite and products are referred to generally as added layers. In one embodiment, these added layers contain thermoplastic low-melting adhesive. Alternatively, the added layers are attached to the products using a separate sublayer containing a thermoplastic low-melting adhesive material or soluble polymeric adhesive material, powdered material, or other adhesives.

The added layers are removed from the products, either partially or completely. When the added layers are attached with adhesive layers, the added layers and adhesive layers are either partially or completely removed. In one embodiment, at least one of heat and solvents are applied to exposed surfaces of the added layer or added layers to be removed. Application of heat, solvents or heat and solvents yields added layers that are softened, molten, or dissolved. The heat and solvent loosen the added layer or added layers. In one embodiment abrasion or perforations are pre-applied to the added layer to expedite the propagation and action of the applied heat and solvents. The added layer is then removed to facilitate processing of the composite or product through a recycling process to produce recycled raw material. In one embodiment, the added layer is removed from the product using one or more physical removal processes. Suitable physical removal processes include, but are not limited to, peeling, squeezing-off molten or dissolved polymer, abrasion, shaving and scraping. In one embodiment the initial removal by peeling is followed by the removal of residual adhesive from the textile surface by abrasion, shaving, or other equivalent methods.

In one embodiment, softened or liquified polymer is removed by squeezing-off, i.e., squeezing the composite or product to force the softened or liquified polymer out of and off the composite or product. In one embodiment, the molten or dissolved polymer is removed by applying suction underneath the composite or product or by directing forced blown air onto the composite or product from above. In one embodiment, solvent is introduced on or into the composite or product by immersion of the composite or product in the solvent. In one embodiment, the application of heat, solvent, or heat and solvent and the subsequent partial removal of molten or dissolved polymer is repeated two or more times to reduce the residual polymer level.

Exemplary embodiments are directed to a method for processing a textile composite for recycling where the textile composite contains a textile sheet and an added layer attached to the textile sheet by an adhesive layer. In one embodiment, the textile sheet is a floorcovering. In one embodiment, the added layer is a sheet carrying a continuous or discontinuous layer of pressure sensitive adhesive, and the adhesive layer is a secondary low-melting or soluble adhesive sublayer attaching the added layer to the textile sheet. In one embodiment, the added layer is a fiberglass woven fabric, a fiberglass nonwoven fabric or a fiberglass pre-bonded scrim. In one embodiment, the added layer is a decorative and wear resistant surface fabric, and the adhesive layer is a thermoplastic adhesive. In one embodiment, the added layer is a dissolvable adhesive. In one embodiment, the adhesive layer is a polymeric soluble or low-melting adhesive deployed as a sublayer between the added layer and the textile sheet. In one embodiment, the added layer and adhesive sublayer are two co-formed high-melt/low-melt films or two pre-combined high-melt/low-melt films.

The textile composite is exposed to a surface treatment mechanism to loosen the added layer without melting or dissolving the textile sheet. In one embodiment, the surface treatment mechanism is radiant heating. In one embodiment, the surface treatment mechanism uses heated air directed onto the textile composite. The heated air is at a temperature below a melting point of materials within the textile sheet and above an added layer melting point and an adhesive layer melting point. In one embodiment, exposing the textile composite to the surface treatment mechanism includes applying heat, solvent or heat and solvent to the textile composite to melt or to dissolve the adhesive layer. In one embodiment, the solvent treatment process utilizes a solvent, and the solvent is water, heated water, a ketone, a paraffinic solvent, a napthenic solvent or combinations thereof.

In one embodiment, the textile composite is exposed to a pre-conditioning mechanism to perforate, abrade or mechanically open an outer or exposed surface of the added layer prior to exposing the textile composite to the surface treatment mechanism. Following exposure to the surface treatment mechanism, a removal mechanism is used to remove the loosened added layer and at least a portion of the adhesive layer. In one embodiment, using the removal mechanism includes peeling the added layer from the textile sheet. In one embodiment, using the removal mechanism includes blowing heated air through the textile sheet. In one embodiment, using the removal mechanism includes applying suction to the textile sheet. In one embodiment, the surface treatment mechanism includes applying at least one of heat and solvent to liquefy the adhesive layer and the added layer, and the removal mechanism includes at least partially removing the adhesive layer and added layer adhesive by forcing the liquified adhesive out of the textile sheet. In one embodiment, forcing the liquified adhesive out of the textile sheet involves squeezing the textile sheet. In one embodiment, subsequent re-heating of the textile sheet or introduction of additional solvent is used to minimize residual adhesive content in the textile sheet. In one embodiment, the method includes chopping, shredding or grinding the textile composite before applying heat or solvent and using the removal mechanism.

The textile sheet with the added layer and adhesive layer removed is directed to a recycling process, and the recycled textile sheet is used in a new manufactured product.

Exemplary embodiments are also directed to a method for removing an added layer, e.g., an added outer layer, from each one of a plurality of randomly shaped and randomly arranged pieces of a textile sheet in a continuous process by restraining each piece of the textile sheet on a planar surface and using a removal mechanism in a removal process to remove the added layer from each restrained piece of textile sheet. In one embodiment, restraining each piece of the textile sheet includes using pins, hooks or teeth projecting from a plane on which each piece of textile sheet rests to impale a face of each piece of textile textile sheet opposite the added layer onto the plane. In one embodiment, the plane is a face of a belt or a roll, and each pin, hook, or tooth has a height extending up from the plane that is less than a thickness of each piece of textile sheet. In one embodiment, restraining each piece of textile sheet includes applying vacuum to the face each piece of textile sheet. In one embodiment, using the removal process includes abrading the added layer, shaving the added layer off a surface of each piece of textile sheet or abrading the added layer and shaving the added layer off a surface of each piece of textile sheet.

Exemplary embodiments are also directed to a method of removing an added layer, e.g., an outer layer, from the textile sheet in randomly shaped and randomly placed pieces of a textile composite by attaching the pieces onto a first roller containing perforations and using internal vacuum or projecting pins hold the pieces onto the roller. The surface is abraded off with a second roller, containing an abrasive surface. The distance between the two rollers is adjusted to allow the second roller to reach the desired depth into each piece of textile composite to remove the outer layer.

Exemplary embodiments are also directed to systems and methods for recycling of any composite, article or product containing PSA on at least a portion or a face of the composite. The composite, article or product with the PSA removed is then subjected to a recycling process. In one embodiment, the composite, article or product is a floorcovering or wallcovering back-coated with PSA for attachment to the desired surface, and exemplary embodiments are used to remove the PSA and recycle the floorcoverings or wallcoverings. In one embodiment, the tackiness or tack of any PSA remaining on the composite is reduced or eliminated without removing the PSA from the composite. This reduction or elimination of tackiness or tack from the PSA facilitates recycling of the composite by preventing the PSA from sticking to surfaces within the recycling machines and blocking those recycling machines. Exemplary embodiments reduce or eliminate the tackiness or tack of PSA applied to the underside of modular flooring and to flooring products having with fibrous backsides such as carpet tiles and composite tiles with fibrous backings.

Exemplary embodiments are directed to a method for processing a composite having a first layer and an added layer for recycling. Heat, solvent or heat and solvent are applied to the composite to liquefy the added layer without melting or dissolving the first layer, and the liquified added layer is removed. At least a portion of liquified added layer is forced from the first layer, and the first layer with the added layer is processed in a recycling process to generate a recycled raw material used for incorporation in a new composite. In one embodiment, at least a portion of the liquified added is forced out of the first layer by squeezing the first layer. In one embodiment, removing liquified added layer and forcing at least a portion of the liquified added out of the first layer includes blowing heated air through the first layer, applying suction to the first layer or blowing heated air through the first layer and applying suction to the first layer. Suitable solvents include a ketone, a paraffinic solvent and a napthenic solvent. In one embodiment, the added layer is a pressure sensitive adhesive.

In one embodiment, the composite further includes an adhesive layer between the added layer and the first layer to attach the added layer to the first layer, and heat, solvent or heat and solvent are applied to the composite to liquefy the added layer and the adhesive layer without melting or dissolving the first layer. Liquified added layer and liquified adhesive layer are removed, and at least a portion of liquefied added layer and liquified adhesive layer are forced from the first layer. In one embodiment, the adhesive layer is a polymeric soluble adhesive or a polymeric low-melting adhesive. In one embodiment, a surface of the added layer opposite the first layer is opened before applying heat, solvent or heat and solvent. In one embodiment, opening the surface includes perforating the surface or abrading the surface. In one embodiment, the added layer and adhesive sublayer are two co-formed high-melt/low-melt films or two pre-combined high-melt/low-melt films. In one embodiment, the method further also includes re-heating the first layer with the added layer and adhesive layer removed, introducing additional solvent into the first layer with the added layer and adhesive layer removed or re-heating the first layer with the added layer and adhesive layer removed and introducing additional solvent into the first layer with the added layer and adhesive layer removed to minimize residual adhesive content in the first layer. In one embodiment, the method includes chopping, shredding or grinding the composite before applying heat, solvent or heat and solvent.

Exemplary embodiments are directed to a method for processing a plurality of randomly shaped and randomly arranged pieces of a composite having a first layer and an added layer for recycling in a continuous process. The method includes restraining each piece of the composite on a common surface and removing the added layer from the first layer in each piece of composite. In one embodiment, restraining each piece of the first layer includes using pins, hooks or teeth projecting from the common surface to impale the first layer of each piece of composite opposite the added layer, applying vacuum through the common surface to each piece of composite or using pins, hooks or teeth to impale the first layer and applying vacuum to each piece of composite. In one embodiment, the common surface is a surface of a belt or a surface of a roller. In one embodiment, removing the added layer includes abrading the added layer, shaving the added layer off the first layer or abrading the added layer and shaving the added layer off the first layer.

In one embodiment, restraining each piece of composite involves attaching each piece of composite onto a first roller containing the common surface such that the first layer is in contact with the common surface, and removing the added layer includes contacting the added layer with a second roller comprising an abrasive surface. A distance between the first roller and the second roller is adjusted to remove a desired thickness of the composite. In one embodiment, the first roller is a perforated roller, and restraining each piece of composite uses vacuum applied through the first roller to hold the pieces of composite on the common surface.

Exemplary embodiments are also directed to a method for processing a composite with a first layer and an added layer of pressure sensitive adhesive for recycling. The pressure sensitive adhesive is altered in situ to reduce tackiness of the pressure sensitive adhesive, and the composite containing the altered pressure sensitive adhesive is processed to create recycled raw material. In one embodiment, altering the pressure sensitive adhesive neutralizes the tackiness of the pressure sensitive adhesive. In one embodiment, altering the pressure sensitive adhesive alters physical properties, chemical properties or physical properties and chemical properties of the pressure sensitive adhesive. In one embodiment, the pressure sensitive adhesive is a UV radiation cured polymer, and altering the pressure sensitive adhesive includes exposing the pressure sensitive adhesive to a sufficient amount of additional UV radiation to increase cross-linking within the UV radiation cured polymer and harden the pressure sensitive adhesive. In one embodiment, exposing the pressure sensitive adhesive to a sufficient amount of additional UV radiation includes exposing the pressure sensitive adhesive to UV-C radiation. In one embodiment, exposing the pressure sensitive adhesive to additional UV radiation includes applying the additional UV radiation using a source of radiation directed onto the pressure sensitive adhesive.

In one embodiment, altering the pressure sensitive adhesive includes using electron-beam processing. In one embodiment, altering the pressure sensitive adhesive includes exposing the pressure sensitive adhesive to a sufficient amount of heat to char the pressure sensitive adhesive and neutralize the tackiness. In one embodiment, altering the pressure sensitive adhesive includes coating the pressure sensitive adhesive with granules. In one embodiment, the granules are pressed into the pressure sensitive adhesive. In one embodiment, altering the pressure sensitive adhesive includes applying heat to the pressure sensitive adhesive while pressing the granules into the pressure sensitive adhesive.

In one embodiment, the composite is a vinyl faced floor tile. In one embodiment, the first layer is a textile layer, and the composite includes a textile backing attached to the textile layer. The pressure sensitive adhesive covers at least a portion of the textile backing. In one embodiment, the composite is at least a portion of a flooring tile. In one embodiment, processing the composite containing the altered pressure sensitive adhesive includes cutting the composite, shredding the composite, grinding the composite or combinations thereof. In one embodiment, the method also includes processing the recycled raw material to separate fine ingredients from coarse ingredients. In one embodiment, the recycled raw material is incorporated into a new composite. The composite and the new composite represent a common type of composite. In one embodiment, the new composite is a textile sheet, and incorporating the recycled raw material into the new composite involves blending the recycled raw material with fibers used to manufacture the textile sheet. In one embodiment, the new composite includes a textile sheet, and incorporating the recycled raw material into the new composite involves adhesively attaching the textile sheet to a secondary sheet containing the recycled raw material. In one embodiment, the new composite includes a fibrous textile sheet, and incorporating the recycled raw material into the new composite involves introducing a layer of the recycled raw material between two new textile layers and needling to produce the fibrous textile sheet.

Exemplary embodiments are also directed to a method for processing a composite having a first layer and an added layer of pressure sensitive adhesive for recycling. The pressure sensitive adhesive is altered in situ to reduce tackiness of the pressure sensitive adhesive, and the altered pressure sensitive adhesive is removed from the composite. The composite from which the altered pressure sensitive adhesive was removed is processed to create a recycled raw material. In one embodiment, removing the altered pressure sensitive adhesive further includes removing the altered pressured sensitive adhesive and a portion of the first layer in areas of the first layer covered by the pressure sensitive adhesive. In one embodiment, removing the altered pressure sensitive adhesive includes abrading the altered pressure sensitive adhesive or shaving off the altered pressure sensitive adhesive.

In one embodiment, the pressure sensitive adhesive is a UV radiation cured polymer, and altering the pressure sensitive adhesive includes exposing the pressure sensitive adhesive to a sufficient amount of additional UV radiation to increase cross-linking within the UV radiation cured polymer and harden the pressure sensitive adhesive. In one embodiment, exposing the pressure sensitive adhesive to a sufficient amount of additional UV radiation includes exposing the pressure sensitive adhesive to UV-C radiation. In one embodiment, exposing the pressure sensitive adhesive to additional UV radiation includes applying the additional UV radiation using a source of radiation directed onto the pressure sensitive adhesive. In one embodiment, altering the pressure sensitive adhesive includes using electron-beam processing.

### BRIEF DESCRIPTION OF THE DRAWINGS

The accompanying drawings, which are incorporated in and constitute a part of the specification, illustrate a plurality of embodiments and, together with the following descriptions, explain these embodiments.

FIG. 1 is a schematic representation of a process wherein an added layer attached with a low-melting or soluble sublayer to a textile sheet is removed by applying heat or solvent and peeling the added layer off;

FIG. 2 is a schematic representation of a cross section of a textile sheet with an added layer carrying pressure-sensitive adhesive that is attached to the textile sheet with a low-melting or soluble sublayer to enable the removal of the added layer along with the pressure sensitive adhesive using the process of FIG. 1;

FIG. 3 is a schematic representation wherein a low-melting or soluble added layer attached to a textile sheet directly or with a low-melting or soluble sublayer is first liquified with heat or solvent and then squeezed out of a textile sheet;

FIG. 4 is a schematic representation of process wherein the adhesive contained within an added layer or present within an adhesive sublayer is liquified and extracted by applying compressed air from the opposite side and vacuum from the underlayer side;

FIG. 5 is a schematic representation of an added layer or remnants of an added layer or remnants of adhesive originally holding an added layer being removed from the back of a textile sheet by abrasion, scraping or shaving; and

FIG. 6 is a schematic representation of an embodiment of a system for altering pressure sensitive adhesive on a composite and producing recycled material from the composite containing the altered pressure sensitive adhesive.

### DETAILED DESCRIPTION

The following description of the embodiments refers to the accompanying figures. The same reference numbers in different figures identify the same or similar elements. Reference throughout the whole specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, particular features, structures or characteristics may be combined in any suitable manner in one or more embodiments.

Exemplary embodiments of systems and methods are directed to processing a composite containing at least a first layer and an added layer attached to the first layer. In one embodiment, the added layer is attached to the first layer by a separate adhesive layer. The composite is processed to generate a recycled raw material. At least a portion of one or more components or layers of the composite are altered, removed or altered and removed prior to generating the recycled raw material The recycled raw material contains at least a portion of the components, constituents and materials contained in the composite. The recycled raw material is incorporated into a new composite, including new versions of the same type of composite from which the recycled raw material is obtained. Suitable composites include textile surface coverings, porous textile surface coverings backed with porous textile backings, and textile surface coverings backed with fibrous felts. Other composites containing layers or surfaces to be altered or removed prior to subjecting the composites to a recycling process include, but are not limited to, bumper stickers, tape, padding, stamps, envelopes, cardboard boxes, decals, rubber bumpers, diapers, bandages, molding, carpet, carpet tiles, luxury vinyl tiling (LVT), luxury vinyl plank (LVP), vinyl composite tiles (VCT), laminate squares, and wood flooring.

Following alteration, partial or complete removal of the desired layers or alteration and removal, the remaining layer or layers, e.g., the first layer or textile sheet of a textile composite, is processed into a recycled raw material that is mixed or layered with other materials or fibers to generate a new composite. In one embodiment, the composite and new composite are a common type of composite, and generating the new composite reproduces the original composite. For example, a textile sheet, following removal of the desired unwanted layers, is shredded to create the recycled raw material. This recycled raw material is mixed or layered with other fibers to form a new textile sheet or a new textile composite containing the new textile sheet.

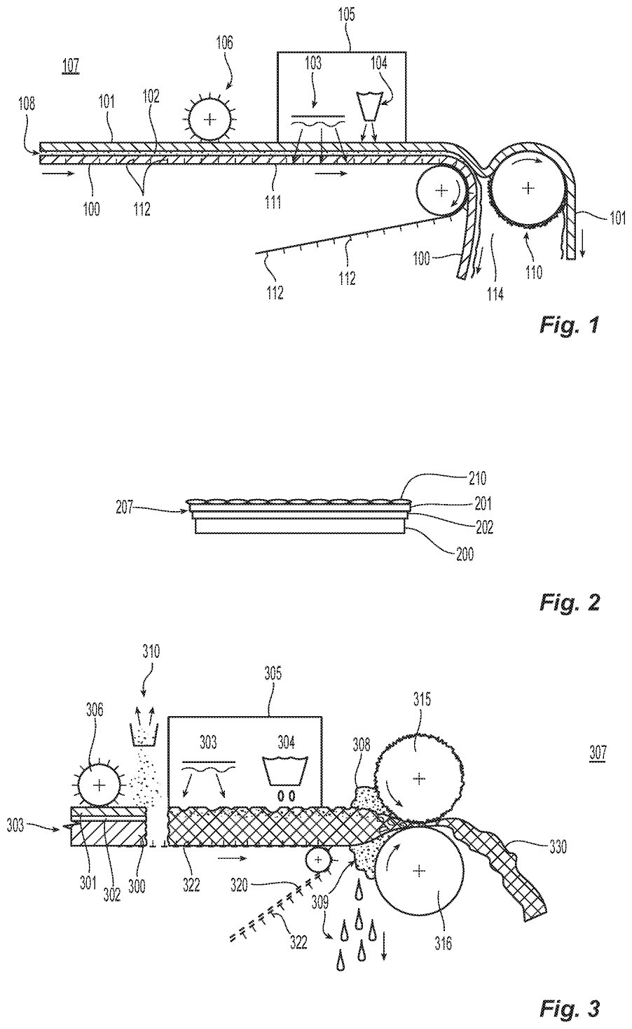

Referring initially to FIG. 1, an embodiment of a process or system 107 for processing a composite 108 is illustrated. As illustrated, the composite is a textile composite; however, the process and system can be used to process any type of composite and to alter, remove, or alter and remove any layer or layers described herein. Suitable textile composites include, but are not limited to, a flooring tile, a piece of edge trim, a rolled sheet of composite carpeting, and a cut piece of carpeting with any planar shape. The textile composite can be a used, rejected or defective flooring tile. The textile composite contains a textile sheet 100 having an added layer 101 attached to a textile sheet 100 by a separate adhesive layer 102. In one embodiment, the separate adhesive layer is a secondary low-melting adhesive layer or a soluble adhesive sublayer. In one embodiment the added layer 101 is a solid layer. In one embodiment, the added layer is a dense flow-resistant layer. Suitable solid layers and dense flow-resistant layers include, but are not limited to, films, sheets of rubber, dense fabrics, dimensionally-stabilizing woven scrims, dimensionally-stabilizing cross-bonded seams, and nonwoven fabrics. In one embodiment, the added layer is constructed from or contains fiberglass. In one embodiment, the added layer is a dimensionally-stabilizing woven or cross-bonded or nonwoven scrim attached with the adhesive layer. In one embodiment the added layer is a liquid blocking barrier layer. In one embodiment, the added layer 101 and the adhesive layer 102 are formed as a coextruded film.

The textile composite is placed on or supported by a surface 111. As illustrated, the textile composite is placed on the surface with the first layer or textile layer in contact with the surface. In one embodiment, the process is a continuous process, and the surface is a moving surface, for example the surface of a conveyor belt. A securing or attachment mechanism is used to hold the textile composite to the surface such that the textile composite moves along or with the moving surface. Therefore, textile composites of any planar shape can be processed by placing them onto the surface in any desired direction or orientation. In one embodiment, the textile composite is secured to the moving surface 111 by an attachment mechanism that includes a plurality of pins 112 extending up from the moving surface. Each pin engages or passes at least partially into the textile composite. In one embodiment each pin is shorter than the depth or thickness of the textile composite under the added layer to avoid interference with the removal of the added layer. In an embodiment with an added layer attached to a first layer or textile layer, each pin extends from the surface a distance less than a thickness of the textile layer. In one embodiment, the textile composite is secured to the moving surface using an attachment mechanism that includes vacuum. The surface or moving surface is a perforated surface, and vacuum is applied under and through the perforated moving surface. In one embodiment, vacuum is applied along the length of the surface. Suitable methods for applying vacuum through a surface or a moving surface are known and available in the art. In one embodiment, the attachment mechanism utilizes both the plurality of pins and the vacuum.

In one embodiment the textile composite initially passes through a pre-conditioning mechanism 106. The pre-conditioning mechanism is located over the added surface and conditions or opens a surface or exposed face of the added layer opposite the textile layer before applying other treatments and removal processes to the textile composite. The surface pre-conditioning mechanism includes devices that perforate or abrade the surface or exposed face added layer and adhesive sublayer. Suitable devices include knives, pins or abrasive protrusions attached to one or more plates, wheels or rollers. In one embodiment, the surface pre-conditioning mechanism 106 is optional.

As the textile composite moves along the moving surface 111, either with or without pre-conditioning, the textile composite passes through a surface treatment process 105. The surface treatment process includes one or more physical or chemical treatment processes that treat or alter the added layer, the adhesive layer or the added layer and the adhesive layer. In one embodiment, the surface treatment process 105 includes a heat treatment process 103, a solvent treatment process 104 or a heat treatment process and a solvent treatment process. In one embodiment, the heat treatment process 103 melts a low-melting adhesive layer 102 and loosens or softens the added layer 101. In one embodiment, the solvent treatment 104 process dissolves a soluble adhesive layer and loosens or softens the added layer. In one embodiment, the surface treatment process, e.g., heat, solvent or heat and solvent, liquefies the added layer, the adhesive layer or the added layer and adhesive layer.

In one embodiment, the heat treatment process 103 uses radiant heaters. In one embodiment, the heat treatment process includes heated air that is blown at or over the added layer. In one embodiment, the solvent treatment process 104 includes spraying. In one embodiment, the solvent treatment process 104 includes liquid transfer rolls (not shown). Other treatment processes include, but are not limited to, a UV light process, a electron-beam process, and a granule coating process.

Following treatment of the added layer and adhesive layer, the textile composite passes through a removal mechanism 110 to separate the added layer 101 from the textile sheet 100. In one embodiment, the removal mechanism also removes the adhesive layer. In one embodiment as illustrated, the removal mechanism includes a roller 110 having a contact surface 114. In one embodiment, the contact surface is an abrasive surface with surface pins or surface teeth. In one embodiment, the contact surface is a perforated surface, and the roller contains an internal vacuum that passes through the perforated surface. The roller can use abrasion, vacuum or abrasion and vacuum to peel the loosened added layer 101, the loosened adhesive layer or the loosened added layer and loosened adhesive layer from the textile sheet. The removed layers are detached from the roller, and detachment of the removed layers can be aided by air jets internal to the roller directed out through the perforated surface, air jets directed tangential to the roller, a scraper or additional high-speed rollers casting-off the removed sheet of added layer 101 centrifugally. When the adhesive layer attaching the added layer to the textile layer is a low melting layer loosened with heat, the removal mechanism is maintained at a high temperature to avoid adhesive build-up in parts of the removal mechanism. The textile sheet 100 with the added layer and adhesive layer removed is then directed to additional processing to make the recycled raw material.

Referring now to FIG. 2, another embodiment of a textile composite 207 that can be processed in accordance with the methods and systems described herein is illustrated. The textile composite includes a textile layer 200 and an added layer 201 attached to the textile layer with an adhesive layer 202. In one embodiment, the adhesive layer is a low-melting adhesive layer or a dissolvable adhesive layer. Pressure-sensitive adhesive (PSA) 210 is attached to or pre-tacked to the added layer 201 on a side opposite the adhesive layer. In one embodiment, the PSA is removed with the added layer. In one embodiment, the PSA is inactivated, e.g., the tackiness of the PSA is removed.

When the adhesive layer 202 is a low-melting layer, heat is applied to melt the adhesive layer 202, and the entire added layer is peeled from the textile sheet with the PSA still attached to the added layer 201, for example, using a process such as the process illustrated in FIG. 1. When the adhesive layer 202 contains a soluble adhesive and the added layer 201 is a solid layer, solvent can be pre-applied to the textile composite from the face of the textile composite opposite the added layer 201, or can be applied by immersion of the textile composite in the solvent. In one embodiment, the solvent is applied before placing the textile composite on the surface of the conveyor. In one embodiment, added layers include a polyester film and a nylon film. In one embodiment, the adhesive layer is Polyvinyl Alcohol (PVA).

Referring now to FIG. 3, another embodiment of a process or system 307 for processing a composite 308 is illustrated. As illustrated, the composite is a textile composite with a textile layer 300 and an added layer 301 attached to the textile layer 300 with an adhesive layer 302. The textile layer, added layer and adhesive layer may be open structure that permits air flow through the textile composite. Alternatively, the textile composite is pre-perforated with a pattern of holes to open the structure to air flow, for example, using conventional means. In one embodiment, the added layer and the adhesive sublayer are soluble in a solvent that does not dissolve the textile sheet 300. Alternatively, the added layer and the adhesive sublayer contain adhesive that melts at a temperature lower that a textile sheet melting temperature.

The textile composite is placed on or supported by a surface 320. As illustrated, the textile composite is placed on the surface with the first layer or textile layer in contact with the surface. In one embodiment, the surface is the surface of a conveyor belt. A securing or attachment mechanism is used to hold the textile composite to the surface such that the textile composite moves along or with the moving surface. In one embodiment, the textile composite is secured to the moving surface 320 by an attachment mechanism that includes a plurality of pins 322 extending up from the moving surface. Each pin engages or passes at least partially into the textile composite. In one embodiment each pin is shorter than the depth or thickness of the textile composite under the added layer to avoid interference with the removal of the added layer. In one embodiment, the textile composite is secured to the moving surface using an attachment mechanism that includes vacuum. The surface or moving surface is a perforated surface, and vacuum is applied under and through the perforated moving surface. In one embodiment, vacuum is applied along the length of the surface. Suitable methods for applying vacuum through a surface or a moving surface are known and available in the art. In one embodiment, the attachment mechanism utilizes both the plurality of pins and the vacuum. In one embodiment the textile composite initially passes through a pre-conditioning mechanism 306. The pre-conditioning mechanism is located over the added surface and conditions or opens a surface or exposed face of the added layer opposite the textile layer before applying other treatments and removal processes to the textile composite. The surface pre-conditioning mechanism includes devices that perforate or abrade the surface or exposed face added layer and adhesive sublayer. Suitable devices include knives, pins or abrasive protrusions attached to one or more plates, wheels or rollers. The pins or protrusions engage and extend into the added layer, the adhesive layer or the added layer and the adhesive layer, facilitating subsequent processing of the added layer and adhesive layer. In one embodiment, the pre-conditioning mechanism is paired with a source of vacuum 310 to remove the surface material extracted by the pre-conditioning mechanism.

With or without the pre-conditioning step, the textile composite then passes through the surface treatment process 305 that includes one or more physical or chemical treatment processes that treat or alter the added layer, the adhesive layer or the added layer and the adhesive layer. In one embodiment, the surface treatment process 305 includes a heat treatment process 303, a solvent treatment process 304 or a heat treatment process and a solvent treatment process. In one embodiment, the heat treatment process includes an oven or a series of radiant heaters. In one embodiment, the solvent treatment process includes a spray or an immersion bath. In one embodiment, the immersion bath contains heated solvent. Alternatively, the solvent is not heated. Suitable solvents include, but are not limited to water, heated water, a ketone, a paraffinic solvent, a napthenic solvent and combinations thereof. In one embodiment, the added layer and adhesive sublayer include polymers, e.g., polyvinyl alcohol (PVA), that are soluble in common solvents that do not affect the properties of the textile sheet.

The treated textile composite then passes through the removal mechanism. The removal mechanism includes a first high-pressure compression roller 315 and a second high-pressure compression roller 316. The treated textile composite is fed into the nip between the first and second high-pressure compression rollers. For the removal of molten or liquified added layers and adhesive layers, the rollers 315 and 316 are maintained at a temperature above both melting points. Dissolved, molten or liquified polymers in the added layer and adhesive sublayer are removed as the textile composite is squeezed between the compression rollers. This produces a puddle 308 that accumulates in front of the nip point of the first and second high-pressure compression rollers. The puddle 308 moves through the openly porous or pre-perforated textile sheet 300 forming a lower puddle 309 adjacent the second compression roller. This lower puddle is collected or falls off the second compression roller. Therefore, the majority of the dissolved, molten or liquified polymer is removed.

In one embodiment, the textile composite is passed iteratively through multiple cycles of the surface treatment process and the removal process. Multiple passes through the surface treatment mechanism and the removal mechanism processes minimize residual added layer and adhesive layer resin on an emerging textile sheet 330, which is then directed to a recycling process. In one embodiment, the added layer melts at a low temperature and has a very high melt index and very low melt viscosity; therefore, the added layer can be effectively removed by squeezing or compressing the textile composite at an elevated temperature. In one embodiment, the textile composite including the added layer and adhesive layer are chopped or shredded and formed into a new layer, and the new layer is subjected to heat, solvent or heat and solvent before removing at least part of the adhesive content by squeezing.

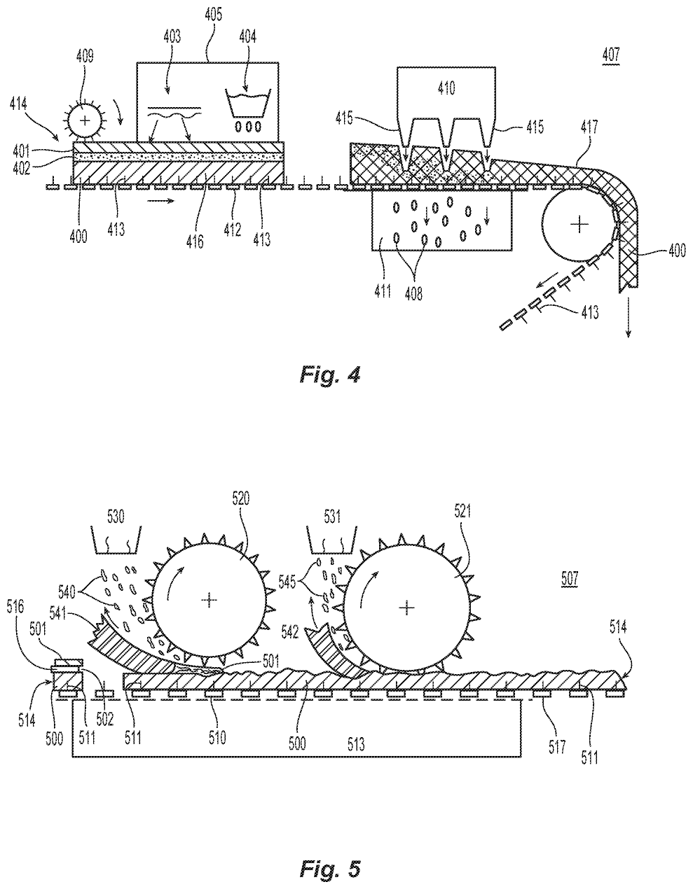

Referring now to FIG. 4, another embodiment of a process or system 407 for processing a composite 414 is illustrated. As illustrated, the composite is a textile composite with a highly open and porous textile layer 400 and an added layer 401 attached to the textile layer with an adhesive layer 402. In one embodiment the textile layer 400 is resistant to air flow, and the textile layer is pre-perforated with an array of pins to open air passages through the textile layer.

The textile composite is placed on or supported by a surface 412. As illustrated, the textile composite is placed on the surface with the first layer or textile layer in contact with the surface. In one embodiment, the surface is the surface of a conveyor belt. A securing or attachment mechanism is used to hold the textile composite to the surface such that the textile composite moves along or with the moving surface. In one embodiment, the textile composite is secured to the moving surface 412 by an attachment mechanism that includes a plurality of pins 413 extending up from the moving surface. Each pin engages or passes at least partially into the textile composite. In one embodiment each pin is shorter than the depth or thickness of the textile composite under the added layer to avoid interference with the removal of the added layer.

In one embodiment, the textile composite is secured to the moving surface using an attachment mechanism that includes vacuum. The surface or moving surface is a perforated surface, and vacuum is applied under and through the perforated moving surface. In one embodiment, vacuum is applied along the length of the surface. Suitable methods for applying vacuum through a surface or a moving surface are known and available in the art. In one embodiment, the attachment mechanism utilizes both the plurality of pins and the vacuum. In one embodiment, textile composite is a continuous sheet of textile composite. Alternatively, the textile composite is arranged and processed as a plurality of uniform or randomly shaped and pieces of composite. These pieces of composite can be uniformly arranged or randomly arranged on the surface; therefore, the surface is a common surface or common support surface for the plurality of pieces of composite. The plurality of pins 413, vacuum or plurality of pins and vacuum hold the randomly shaped pieces of textile composite that can be fed along the conveyor bed in random directionality. As illustrated, two separate pieces of textile composite are placed on the surface of the conveyor belt, a first piece of textile composite 417 and a separate second piece of textile composite 416.

In one embodiment the textile composite, either the continuous textile composite or the plurality of pieces of textile composite, initially passes through a pre-conditioning mechanism 409. The pre-conditioning mechanism is located over the added surface and conditions or opens a surface or exposed face of the added layer opposite the textile layer before applying other treatments and removal processes to the textile composite. The surface pre-conditioning mechanism includes devices that perforate or abrade the surface or exposed face added layer and adhesive sublayer. Suitable devices include, knives, pins or abrasive protrusions attached to one or more plates, wheels or rollers. The pins or protrusions engage and extend into the added layer, the adhesive layer or the added layer and the adhesive layer, facilitating subsequent processing of the added layer and adhesive layer.

With or without the pre-conditioning step, the textile composite then passes through the surface treatment process 405 that includes one or more physical or chemical treatment processes that treat or alter the added layer, the adhesive layer or the added layer and the adhesive layer. In one embodiment, the surface treatment process 405 includes a heat treatment process 403, a solvent treatment process 404 or a heat treatment process and a solvent treatment process. At least one of heat and solvent are applied to the entire textile composite 414 or to each one of the plurality of pieces of textile composite.

Following surface treatment of the textile composite, the textile composite passes through the removal mechanism. The removal mechanism includes a source of compressed air 410, a vacuum chamber 411 or a source of compressed air and a vacuum chamber. Compressed air is directed from a plurality of nozzles through the textile composite, pushing dissolved, molten or liquified added layer, adhesive layer or added layer and adhesive layer 408 through the textile sheet. In one embodiment, the dissolved, molten or liquified added layer, adhesive layer or added layer and adhesive layer is low-viscosity polymer or polymer solution. In one embodiment, the dissolved, molten or liquified added layer, adhesive layer or added layer and adhesive layer is forced through the textile sheet using compressed through the plurality of nozzles 415 directed to the textile composite. In one embodiment, the compressed air is heated air. In one embodiment, the vacuum chamber 411 is disposed against a surface of the textile sheet opposite the source of compressed air, and vacuum is used to extract the dissolved, molten or liquified added layer, adhesive layer or added layer and adhesive layer 408. The textile sheet 400 with the added layer, adhesive layer or added layer and adhesive layer removed is then sent to a recycling process to generate recycled raw material.

Arrangements of composites include a first layer having an added layer attached with at least one adhesive layer. In one embodiment, the added layer and adhesive layer are free of tacky adhesive. Alternatively, at least a portion of the added layer, opposite the adhesive layer and first layer includes a PSA. In one embodiment, the added layer is a PSA layer. When the added layer and adhesive layer are free of tacking adhesive, the composite can be exposed directly to surface treatments to remove the added layer and adhesive layer. When the composite includes a tack layer such as PSA, the PSA is altered to neutralize or remove the tackiness before the composite is exposed to surface treatments. Suitable methods and apparatus for altering the PSA as discussed herein.

Referring now to FIG. 5, another embodiment of a process or system 507 for processing a composite 514 is illustrated. As illustrated, the composite is a textile composite with a textile layer 500 and an added layer 501 attached to the textile layer with an adhesive layer 502. As illustrated, the textile composite is arranged as a plurality of separate pieces of textile composite, a first textile composite piece 516 and a second textile composite piece 517. The added layer and adjacent adhesive layer of the textile composite are free of tacky adhesive, e.g., PSA, or the PSA on the added layer has been altered or neutralized to remove the tackiness. In one embodiment, the added layer is a continuous or discontinuous PSA layer directly applied onto the back surface of a single textile sheet or a composite textile sheet.

The textile composite is placed on an open conveyor surface 510, and a holding system of shallow pins 511 extending from the open conveyor surface 510 secures each piece of textile composite to the conveyor surface. In one embodiment, a vacuum bed 513 is added under the conveyor surface and is used to hold the textile composite 514 to the conveyor surface as the textile composite passes under a first abrading roller 520 and a second abrading roller 521. The abrading rollers shave off the added layer or the added layer and any adhesive sublayer.

A first vacuum nozzle 530 is associated with the first abrading roller and collects the shaved material 540 generated by the first abrading roller. Similarly, a second vacuum nozzle 531 is associated with the second abrading roller and collects the shaved material 545 generated by the second abrading roller. In one embodiment, a first guide plate 541 is associated with the first abrading roller, and a second guide plate 542 is associated with the second abrading roller. The guide plates are used to guide the textile composite under the abrading rollers and to shield the removed material from vacuum applied underneath. Removal by abrasion or shaving generates shaved material containing short fibers or fibrids. These short fibers can also be separately and usefully recycled into denser textile or nontextile products. In one embodiment the shaved material is blended using at least one of melting and dissolving to introduce the shaved material into plastics or fibers.

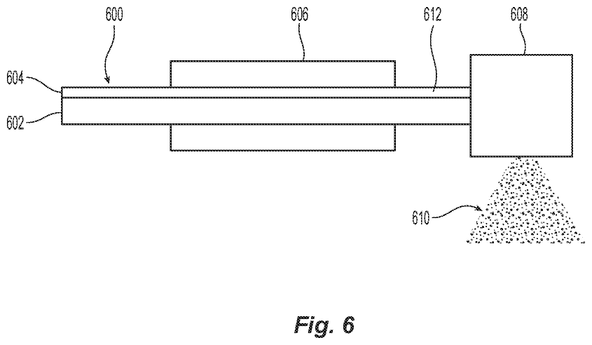

Referring now to FIG. 6, exemplary embodiments are directed the use of the methods and systems discussed herein to process composites 600 with a first layer 602 and an added layer 604 containing PSA on one or more surfaces for recycling. In general, PSA can be applied to any surface or face of any composite and any layer of any composite including the first layer and the added layer. Processing of the composite containing PSA includes passing the composite through a treatment process 606 to alter the PSA to remove or neutralize tackiness followed by processing the composite containing the neutralized PSA in a recycling process 608 to generate recycled raw material 610. Alternatively, the PSA is altered and the altered PSA is removed from the composite, for example, using a process as illustrated in FIG. 5, before processing the composite containing the neutralized PSA to generated recycled raw material.

Suitable composites include, but are not limited to, bumper stickers, tape, padding, stamps, envelopes, cardboard boxes, decals, rubber bumpers, diapers, bandages, and molding. Flooring products also utilize PSA for attachment to the desired surface or adhered, e.g., a wall or floor. These flooring products include, for example, carpet, carpet tiles, luxury vinyl tiling (LVT), luxury vinyl plank (LVP), vinyl composite tiles (VCT), laminate squares, and wood. In modular flooring tiles, PSA serves as a regular adhesive, and when the flooring tile is recycled, the PSA is neutralized to facilitate ease of recycling. In one embodiment, the composite, e.g., flooring tile or other article of manufacture, is included as recycled-content, i.e., recycled raw material, in the subsequent manufacture of the same product or article. The resulting overall process, while neutralizing the tackiness of the PSA, has a negligible effect, if any, on the physical or chemical properties of the composite to which the PSA was attached. The composite can be the entire manufactured article or a portion of the manufactured article, e.g., a piece or section of a flooring tile.

The PSA adhesive is altered in situ, i.e., on the composite or layer of composite on which the PSA is attached. Altering the PSA at least reduces the tackiness of the PSA. In one embodiment, altering the PSA neutralizes or completely eliminates the tackiness. Altering the PSA includes altering at least one of the physical properties or chemical properties, e.g., cross linking, of the PSA. The treatment process and method of altering the PSA is dependent on the type of PSA. Suitable treatment processes and methods include, but are not limited to, radiation methods, heating methods and masking methods. In one embodiment, these methods and the structures for performing these methods are incorporated into the systems illustrated in FIGS. 1, 3, 4 and 5. For example, radiation, heating and masking methods are incorporated in the surface treatment processes. Regardless of the method and apparatus used to alter the PSA, the PSA is altered without a substantial effect on the physical or chemical properties of the composite containing the PSA.

Exemplary embodiments of the systems and methods for processing composites containing PSA are described below with respect to modular flooring tile composites. However, each example applies equally to any composite, article or item that is backed with or utilizing PSA for attachment to a surface and that can be recycled by mechanical recycling processes. Suitable mechanical recycling processes are known and available in the art and include, but are not limited to, cutting, shredding, grinding, abrading or shaving the composite containing the altered PSA.

In one embodiment, the PSA is prepared using a hot melt adhesive containing a photo-initiated cross-linking mechanism. The PSA is cured or cross-linked to a desired degree by varying a length of exposure to a source of ultraviolet radiation. The PSA is applied to a surface of a composite, i.e., the flooring tile, as a hot melt and immediately cured to the appropriate level of tackiness by exposing the adhesive to a controlled amount of energy from an ultraviolet radiation source. This UV radiation source is preferably UV Type C (UV-C) radiation (100-280 nm). UV-C radiation does not naturally occur inside the Earth's atmosphere. Therefore, the PSA cannot be further cured by exposure to normally occurring light or radiation sources. As an alternative to UV-C radiation, UV-A (315-400 nm) and UV-B (280-315 nm) radiation can be used. In general, any UV spectrum wavelength from 10 to 400 nano-meters is suitable as long as the polymer photo-initiators are formulated to be activated at the wavelength of UV radiation used.

When the flooring tile has achieved a prescribed serviceable life span, or for flooring tiles rejected during manufacturing because of manufacturing defects, the flooring tiles or portions of the flooring tiles are processed into a recycled raw material, as illustrated in FIG. 6, that is used in the manufacture of a recycled content article, e.g., a new flooring tile containing the recycled raw material. The PSA on the flooring tiles to be recycled is exposed again to the same source or type of UV radiation in the treatment process 606. The flooring tiles containing the PSA are exposed to excess amounts of UV radiation or are exposed to a similar level of UV radiation used to cure the PSA but for longer exposure times to complete the curing or cross-linking processes fully. The resulting altered PSA 612 is a fully cured polymer with the tackiness or pressure sensitive properties removed through full crosslinking.

The flooring tile with altered PSA is then subjected to the recycling process 608 to produce the desired raw material 610. In one embodiment, the flooring tile with altered PSA is further processed with additional surface treatment steps as described herein to remove the PSA (FIG. 5), added layers of the composite and adhesives layers attaching the added layers. The recycling process applied to the flooring tile with altered PSA or with altered and removed PSA utilizes conventional shredding, grinding, abrasive or shaving methods as the PSA is no longer tacky and will not gum up, clog, or interfere with the machinery. In one embodiment, the shredded or ground stream of recycled raw material is further processed using a cyclone separator or centrifuge to separate the finer components from the coarser components to produce recycled raw material having desired properties in subsequent manufacturing processes.

In one embodiment, an acrylic polymer with a photo-initiated cross-link is used in the PSA to cure the PSA. After the PSA is applied to the desired surface or layer of the flooring tile, the flooring tile passes a light bed, and UV-C radiation is applied onto the PSA-coated surface, initiating crosslinking in the acrylic polymer. When the flooring tile is processed into recycled raw material, the PSA is exposed to sufficient additional UV-C radiation to harden the adhesive fully, removing any tackiness in the PSA. The UV-C radiation does not reach the other components of the flooring tile or adversely affect the physical and chemical properties of those components.

In one embodiment, altering of the PSA using UV radiation utilizes a line-of-sight method to cure the PSA and to alter the PSA for recycling. In one embodiment, altering of the PSA in the flooring tile to be recycled utilizes a treatment process 606 that does not require line-of-sight. In this embodiment, altering the PSA utilizes electron-beam processing, E-Beam curing or electron irradiation to remove the tackiness of the PSA. In one embodiment, the flooring tile is passed through an E-Beam source, for example, a Beta chamber or Beta radiation chamber, to initiate crosslinking in the polymer. E-Beam technology generates sufficient radiation to cure a photo-initiated polymer fully without the line-of-sight requirement for UV light-based chemistries. The PSA is exposed to a sufficient amount of radiation to harden the PSA fully and remove any tackiness. In one embodiment, a light bed on a conveyor belt is used to apply the radiation without having to expose the surface containing the PSA directly to the radiation. The E-Beam energy passes completely through all of the components of the flooring tile, i.e., the composite, but does not affect the properties of those components.

In another embodiment a polymer with any type of cure mechanism is used to activate the crosslinking in the PSA. The flooring tile is passed through a cryogenic chamber such as liquid nitrogen or dry-ice solution. The PSA is taken below its glass transition temperature, and fully hardened by freezing the adhesive. In one embodiment, the tile is cryogenically processed through shredders or hammermills to break off and grind and powderize the hardened PSA polymer. In one embodiment, cyclone separators or centrifugal separators are used to separate the hard and heavy particles from the shredded and ground fiber content.

In one embodiment, a polymer with any type of cure mechanism is used, and the flooring tile is passed through a heating process that chars the PSA and eliminates tackiness. In one embodiment, heat is applied using a heated roll or heated belt placed in contact with the PSA, while a cool or cooled roll is applied against the surface of the flooring tile opposite the PSA. In one embodiment, radiant heat is directed onto the PSA, while cooling is directed onto the surface of the flooring tile opposite the PSA. In one embodiment, the finer charred content of the recycled raw material produced by cutting or chopping and grinding the flooring tile with altered PSA is separated from coarser charred content using centrifugal or cyclone equipment.

In one embodiment, the PSA utilizes any suitable curing mechanism, and the PSA is altered using the introduction of granules onto or over the PSA. Suitable granules include, but are not limited to, fine powder, particles and fibrids. The granules neutralize or reduce tackiness, and are introduced before or during the mechanical recycling processes to prevent clumping, sticking and blocking the recycling equipment. In one embodiment, the granules are a fine powder, e.g., polyester, calcium carbonate (CaCO₃), or talcum. The granules are spread over the PSA and are forced or pressed into the PSA. The granules can be forced into the PSA with heating or without heating. As an alternative to applying granules directly onto the PSA, granules, e.g., powder, are introduced into the recycling equipment, e.g., the shredder or grinder, to prevent the PSA from interfering with the recycling equipment. In one embodiment, the granules are utilize in an amount that constitutes a very low percentage of the total weight of the recycled raw material and that does not interfere with further processing of the recycled raw material.

In one embodiment, the granules are ground material obtained by chopping and grinding a flooring tile. The finely powdered or finely pulped flooring tile granules function like talcum powder, calcium carbonate powder and cryogenically ground polyester to neutralize the tackiness of the PSA. This chopped and ground flooring tile may or may not have originally contained PSA. The resulting granules are scattered over the PSA. In one embodiment, the granules are also forced into the PSA. The composite, e.g., the flooring tile, containing the altered PSA is then subjected to the desired mechanical recycling process. In one embodiment, heavier fibrous components in the granules derived from the flooring tiles are separated from pulped microfibers and the powder created by the grinding process. Suitable separation methods utilize centrifugal action.

In one embodiment, the composite is a textile composite floorcovering tile having a non-woven backing that can be removed from the composite and shredded and ground into powder and pulped short fibers or fibrids after the pressure sensitive adhesive has been neutralized or fully hardened. This recycled raw material is then introduced into a new nonwoven backing by blending or placing the recycled material within or between new separate non-woven layers. In one embodiment, needling is used to produce a new needle-punched non-woven backing.

Exemplary embodiments are directed to a method for recycling a composite containing pressure sensitive adhesive that alters in situ pressure sensitive adhesive covering one or more areas or surfaces of an composite to reduce tackiness of the pressure sensitive adhesive. The pressure sensitive adhesive at least partially covers a surface of the composite. In one embodiment, the pressure sensitive adhesive completely covers a surface of the composite. The composite can be a portion of a manufactured article or a complete manufactured article. For example, the composite is a floor tile such as a vinyl faced floor tile or at least a portion of the floor tile. In one embodiment, the composite is a textile composite having a textile backing. The pressure sensitive adhesive covers at least a portion of the textile backing. Alternatively, the composite includes a textile face layer and a textile backing, and the pressure sensitive adhesive covers at least a portion of the textile backing.

The method used to alter the PSA depends on the location of the pressure sensitive adhesive, the size of the composite, the type of composite and the type of pressure sensitive adhesive. These methods alter at least one of physical properties and chemical properties of the pressure sensitive adhesive and preferably of only the pressure sensitive adhesive, i.e., other components of the composite to which the pressure sensitive adhesive is attached are not altered. Altering the pressure sensitive adhesive includes neutralizing the tackiness of the pressure sensitive adhesive and completely eliminating the tackiness of the pressure sensitive adhesive.

In one embodiment, the pressure sensitive adhesive is a UV radiation cured polymer, i.e., UV radiation was used in the initial curing of the PSA. In one embodiment, a line-of-sight method is used to alter the PSA by exposing the pressure sensitive adhesive to a sufficient amount of additional UV radiation to increase cross-linking and harden the pressure sensitive adhesive. This reduces or eliminates the tackiness. Preferably, the UV radiation is UV-C radiation. For the line-of-sight application of the UV radiation, a source of additional UV radiation is directed onto the pressure sensitive adhesive. In one embodiment, the PSA is exposed to radiation that is not directed onto the PSA. Instead, electron-beam processing is used to expose the PSA to radiation. In another embodiment, heat is used to alter the PSA. Therefore, the pressure sensitive adhesive is exposed to a sufficient amount of heat to char the pressure sensitive adhesive and to neutralize the tackiness.

Other methods mask or cover the PSA. For example, the pressure sensitive adhesive is coated with granules. Suitable granules include, but are not limited to, powders, pulps, microfibers and mixtures thereof. In one embodiment, the granules contain calcium carbonate powder or talcum powder. In another embodiment, the granules represent ground material derived from an alternative composite that is free of pressure sensitive adhesive. This alternative composite can be the same as the composite to which the PSA is attached or can be a different type of composite. In addition to coating the PSA with granules, the granules can be pressed into the pressure sensitive adhesive. The granules can be pressed into the PSA either with heating or without heating.

Following alteration of the PSA, the composite containing the altered pressure sensitive adhesive is processed to create recycled raw material. Suitable methods for processing the composite include, but are not limited to, cutting the composite, shredding the composite, grinding the composite and combinations thereof. The resulting recycled raw material can be further processed, e.g., filtered or screened, to separate fine ingredients from coarse ingredients. In one embodiment, centrifugation or cyclone processing is used to separate the fine ingredients from the coarse ingredients. In one embodiment, recycling equipment is used to process the composite, and granules are introduced into the recycling equipment to prevent interference between the recycling equipment and the raw material, e.g., the PSA, that would cause particles to adhere to the recycling equipment. The granules introduced into the recycling equipment include, but are not limited to, powders, pulps, microfibers and mixtures thereof.

The resulting recycled raw material is used to manufacture a recycled-content composite or article. This can be a new article or new composite that is the same as the composite that was recycled or a new different type of composite. In one embodiment, the composite and the recycle-content composite are a common type of composite that is produced using a common manufacturing process. The recycled raw material is used to manufacture the recycled-content composite by introducing the recycled raw material into the given manufacturing process. For example, the recycled-content composite is a textile sheet, and the recycled raw material is blended with fibers used to manufacture the textile sheet. In another example, the recycled-content composite is a textile sheet, and the recycled raw material is incorporated into a secondary sheet that is adhesively attached to the textile sheet. For a recycled-content composite that is a fibrous composite sheet, a layer of the recycled raw material is introduced between two new textile layers. The two new textile layers are then needled to produce the fibrous composite sheet.

Exemplary embodiments are also directed to a method for recycling a composite containing pressure sensitive adhesive that alters the pressure sensitive adhesive covering one or more areas of the composite in situ to reduce tackiness of the pressure sensitive adhesive. However, the altered pressure sensitive adhesive is removed from the composite before the composite from which the altered pressure sensitive adhesive was removed is processed to create recycled raw material this is used to manufacture the recycled-content composite. Methods for altering the adhesive, processing the composite, and using the raw material to manufacture the recycled-content article are discussed above for embodiments in which the altered PSA is not removed.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for processing a composite comprising a first layer and an added layer for recycling, the method comprising:
applying heat, solvent or heat and solvent to the composite to liquefy the added layer without melting or dissolving the first layer;
removing liquified added layer;
forcing at least a portion of liquified added layer from the first layer; and
processing the first layer with the added layer in a recycling process to generate a recycled raw material used for incorporation in a new composite.

2. The method of claim 1, wherein forcing at least a portion of the liquified added out of the first layer comprises squeezing the first layer.

3. The method of claim 1, wherein removing liquified added layer and forcing at least a portion of the liquified added out of the first layer comprise blowing heated air through the first layer, applying suction to the first layer or blowing heated air through the first layer and applying suction to the first layer.

4. The method of claim 1, wherein the solvent comprises a ketone, a paraffinic solvent or a napthenic solvent.

5. The method of claim 1, wherein the added layer comprises a pressure sensitive adhesive.

6. The method of claim 1, wherein the composite further comprises an adhesive layer between the added layer and the first layer to attach the added layer to the first layer;
applying heat, solvent or heat and solvent further comprises applying heat, solvent or heat and solvent to the composite to liquefy the added layer and the adhesive layer without melting or dissolving the first layer;
removing liquified added layer further comprises removing liquefied added layer and liquified adhesive layer; and
forcing at least a portion of liquified added layer from the first layer further comprises forcing at least a portion of liquefied added layer and liquified adhesive layer from the first layer.

7. The method of claim 6, wherein the adhesive layer comprises a polymeric soluble adhesive or a polymeric low-melting adhesive.

8. The method of claim 1, wherein the method further comprises opening a surface of the added layer opposite the first layer before applying heat, solvent or heat and solvent.

9. The method of claim 8, wherein opening the surface comprises perforating the surface or abrading the surface.

10. The method of claim 6, wherein the added layer and adhesive sublayer comprise two co-formed high-melt/low-melt films or two pre-combined high-melt/low-melt films.

11. The method of claim 6, wherein the method further comprises re-heating the first layer with the added layer and adhesive layer removed, introducing additional solvent into the first layer with the added layer and adhesive layer removed or re-heating the first layer with the added layer and adhesive layer removed and introducing additional solvent into the first layer with the added layer and adhesive layer removed to minimize residual adhesive content in the first layer.

12. The method of claim 1, wherein the method further comprises chopping, shredding or grinding the composite before applying heat, solvent or heat and solvent.

13. A method for processing a plurality of randomly shaped and randomly arranged pieces of a composite comprising a first layer and an added layer for recycling in a continuous process, the method comprising:
restraining each piece of the composite on a common surface; and
removing the added layer from the first layer in each piece of composite.

14. The method of claim 13, wherein restraining each piece of the first layer comprises using pins, hooks or teeth projecting from the common surface to impale the first layer of each piece of composite opposite the added layer, applying vacuum through the common surface to each piece of composite or using pins, hooks or teeth to impale the first layer and applying vacuum to each piece of composite.

15. The method of claim 13, wherein the common surface comprises a surface of a belt or a surface of a roller.

16. The method of claim 13, wherein removing the added layer comprises abrading the added layer, shaving the added layer off the first layer or abrading the added layer and shaving the added layer off the first layer.

17. The method of claim 13, wherein:
restraining each piece of composite comprises attaching each piece of composite onto a first roller comprising the common surface such that the first layer is in contact with the common surface;
removing the added layer comprises contacting the added layer with a second roller comprising an abrasive surface; and
adjusting a distance between the first roller and the second roller to remove a desired thickness of the composite.

18. The method of claim 17, wherein:
the first roller comprises a perforated roller; and
restraining each piece of composite further comprises using vacuum applied through the first roller to hold the pieces of composite on the common surface.

19. A method for processing a composite comprising a first layer and an added layer of pressure sensitive adhesive for recycling, the method comprising:
altering the pressure sensitive adhesive in situ to reduce tackiness of the pressure sensitive adhesive; and
processing the composite containing the altered pressure sensitive adhesive to create recycled raw material.

20. The method of claim 19, wherein altering the pressure sensitive adhesive comprises neutralizing the tackiness of the pressure sensitive adhesive.

21. The method of claim 19, wherein altering the pressure sensitive adhesive comprises altering physical properties, chemical properties or physical properties and chemical properties of the pressure sensitive adhesive.

22. The method of claim 19, wherein:
the pressure sensitive adhesive comprises a UV radiation cured polymer; and
altering the pressure sensitive adhesive comprises exposing the pressure sensitive adhesive to a sufficient amount of additional UV radiation to increase cross-linking within the UV radiation cured polymer and harden the pressure sensitive adhesive.

23. The method of claim 21, wherein exposing the pressure sensitive adhesive to a sufficient amount of additional UV radiation comprises exposing the pressure sensitive adhesive to UV-C radiation.

24. The method of claim 22, wherein exposing the pressure sensitive adhesive to additional UV radiation comprises applying the additional UV radiation using a source of radiation directed onto the pressure sensitive adhesive.

25. The method of claim 19, wherein altering the pressure sensitive adhesive comprises using electron-beam processing.

26. The method of claim 19, wherein altering the pressure sensitive adhesive comprises exposing the pressure sensitive adhesive to a sufficient amount of heat to char the pressure sensitive adhesive and neutralize the tackiness.

27. The method of claim 19, wherein altering the pressure sensitive adhesive comprises coating the pressure sensitive adhesive with granules.

28. The method of claim 27, wherein altering the pressure sensitive adhesive further comprises pressing the granules into the pressure sensitive adhesive.

29. The method of claim 27, wherein altering the pressure sensitive adhesive further comprises applying heat to the pressure sensitive adhesive while pressing the granules into the pressure sensitive adhesive.

30. The method of claim 19, wherein the composite comprises a vinyl faced floor tile.

31. The method of claim 19, wherein the first layer comprises a textile layer and the composite further comprises a textile backing attached to the textile layer, the pressure sensitive adhesive covering at least a portion of the textile backing.

32. The method of claim 19 wherein the composite comprises at least a portion of a flooring tile.

33. The method of claim 19, wherein processing the composite containing the altered pressure sensitive adhesive comprises cutting the composite, shredding the composite, grinding the composite or combinations thereof.

34. The method of claim 19, wherein the method further comprises processing the recycled raw material to separate fine ingredients from coarse ingredients.

35. The method of claim 19, wherein the method further comprises incorporating the recycled raw material into a new composite, the composite and the new composite comprising a common type of composite.

36. The method of claim 35, wherein:
the new composite comprises a textile sheet; and
incorporating the recycled raw material into the new composite comprises blending the recycled raw material with fibers used to manufacture the textile sheet.

37. The product of claim 35, wherein:
the new composite comprises a textile sheet; and
incorporating the recycled raw material into the new composite comprises adhesively attaching the textile sheet to a secondary sheet containing the recycled raw material.

38. The method of claim 35, wherein:
the new composite comprises a fibrous textile sheet; and
incorporating the recycled raw material into the new composite comprises introducing a layer of the recycled raw material between two new textile layers and needling to produce the fibrous textile sheet.

39. A method for processing a composite comprising a first layer and an added layer of pressure sensitive adhesive for recycling, the method comprising:
altering the pressure sensitive adhesive in situ to reduce tackiness of the pressure sensitive adhesive;
removing the altered pressure sensitive adhesive from the composite; and
processing the composite from which the altered pressure sensitive adhesive was removed to create a recycled raw material.

40. The method of claim 39, wherein removing the altered pressure sensitive adhesive further comprises removing the altered pressured sensitive adhesive and a portion of the first layer in areas of the first layer covered by the pressure sensitive adhesive.

41. The method of claim 39, wherein removing the altered pressure sensitive adhesive comprises abrading the altered pressure sensitive adhesive or shaving off the altered pressure sensitive adhesive.

42. The method of claim 39, wherein:
the pressure sensitive adhesive comprises a UV radiation cured polymer; and
altering the pressure sensitive adhesive comprises exposing the pressure sensitive adhesive to a sufficient amount of additional UV radiation to increase cross-linking within the UV radiation cured polymer and harden the pressure sensitive adhesive.

43. The method of claim 42, wherein exposing the pressure sensitive adhesive to a sufficient amount of additional UV radiation comprises exposing the pressure sensitive adhesive to UV-C radiation.

44. The method of claim 42, wherein exposing the pressure sensitive adhesive to additional UV radiation comprises applying the additional UV radiation using a source of radiation directed onto the pressure sensitive adhesive.

45. The method of claim 39, wherein altering the pressure sensitive adhesive comprises using electron-beam processing.
